(19) United States
(12) Patent Application Publication
(10) Pub. No.: US 2024/0289519 A1
(43) Pub. Date: Aug. 29, 2024

(54) METHOD AND DEVICE FOR IDENTIFYING A CUSHION ELEMENT FROM A QUANTITY OF DIFFERENT CUSHION ELEMENTS

(71) Applicant: MOTESQUE GMBH & CO. KG, Köln (DE)

(72) Inventors: Kai OBERLÄNDER, Köln (DE); Tobias FINK, Köln (DE); Tobias LANG, Brooklyn, NY (US)

(21) Appl. No.: 18/003,544

(22) PCT Filed: Jul. 1, 2021
(86) PCT No.: PCT/EP2021/068175

§ 371 Date: Dec. 28, 2022

(30) Foreign Application Priority Data
Jul. 1, 2020 (DE) 10 2020 117 351.2

(51) Int. Cl. G06F 30/23; G06F 111/16

(52) U.S. Cl. CPC G06F 30/23; G06F 2111/16

(57) ABSTRACT

The invention relates to a method for determining at least one upholstery element from a set of mutually different upholstery elements in relation to a specific person, wherein the upholstery elements are able to be elastically deformed as a result of person-related loading on an upholstered surface of the respective upholstery element, wherein the method comprises the following steps:
Providing a plurality of precomputed digital upholstery models that are each assigned to a specific upholstery element from the set of upholstery elements, wherein each digital upholstery model defines a respective mechanical cushioning property for a multiplicity of areas on the upholstered surface of the upholstery element;
Providing a body model of the person in question for whom the upholstery element is to be determined, wherein the body model contains a description of physiological body properties of the person in question;
wherein, for each provided cushion model or a subset thereof, the following is performed individually by way of a computing unit of a data processing system:
Computing a virtual body loading on a selected body surface of the body of the person in question in relation to person-related loading of the upholstered surface of the upholstery element assigned to the respective upholstery model as a function of the corresponding mechanical cushioning properties of the respective upholstery model and the physiological body properties of the body model of the person in question, and
Determining at least one loading index as a function of the computed virtual body loading and assigning the at least one loading index to the upholstery element concerning the respective upholstery model;
wherein at least one upholstery element is then determined from the set of mutually different upholstery elements as a function of the loading indices assigned to the respective upholstery elements by way of the computing unit.

The invention relates to a method for determining an upholstery element from a set of mutually different upholstery elements in relation to a specific person, wherein the upholstery elements are able to be elastically deformed as a result of person-related loading on an upholstered surface of the respective upholstery element. The invention likewise relates to a data processing system and to a computer program for this purpose.

The invention furthermore relates to a method for creating a digital upholstery model of an upholstery element that is able to be elastically deformed as a result of person-related loading on an upholstered surface of the upholstery element.

Generic upholstery elements, such as for example mattresses, cushions for seating elements and the like, generally serve to achieve the most comfortable possible pressure loading on a person on account of their own weight (weight force) in a specific situation or position. For example, mattresses thus serve to cushion and distribute the weight force resulting from the person's own weight as comfortably as possible when sleeping and thus enable a restful sleep. The upholstery element also serves to ensure the most comfortable possible seating experience in the case of seating elements, such as for example seat cushions for furniture (for example chairs, armchairs, sofas, car seats, etc.). However, upholstery elements are also found in other areas that are intended to at least partially support or cushion the body against a hard surface. Such upholstery elements are found for example in garments, such as for example sneakers.

The property of an upholstery element of supporting or cushioning the body of a specific person against a hard surface as comfortably as possible is perceived in a highly individual manner. By way of example, a mattress may thus be perceived to be particularly comfortable by a first person, and thus lead to a particularly restful sleeping experience, while this mattress is perceived to be uncomfortable by a different, second person.

The reasons for this are highly diverse. On the one hand, every body is different in terms of its physiological properties and differs, which means that the interaction of the body with the respective upholstery element ends up being highly individual. On the other hand, every person has certain usage preferences (for example back sleepers, side sleepers, stomach sleepers in the case of mattresses), which likewise influence the perception of the usage comfort of upholstery elements.

A specific upholstery element is therefore at present selected in practice almost entirely by trying it out. The person in question for this purpose visits a specialist shop where a limited selection of upholstery elements are available to try out. However, it has been shown, especially in the case of mattresses, that lying down for less than 3 minutes generally creates a false perception of comfort, since the mattress reacts with a changing restoring force as loading increases. It may therefore be the case that the initial perception of a particularly comfortable position proves to be uncomfortable over the long term. Therefore, trying out upholstery elements in specialist shops rarely leads to an optimum selection of the desired upholstery element.

In addition to this, there are possibilities of reducing the number of upholstery elements to be selected, for example in a specialist shop that operates purely online, by querying user preferences and, if necessary, specifying a suggestion for a good selection. However, this cannot replace trying out the upholstery element, since only usage preferences are used for the selection, but not the individual perception of the mechanical cushioning property of the upholstery element. Under some circumstances, the upholstery element then has to be sent back at great expense or the user has to put up with the non-optimum upholstery element.

The object of the present invention is therefore to specify an improved method and device for determining an upholstery element, by way of which method and device the negative effects of trying out upholstery elements are able to be avoided.

According to the invention, the object is achieved using the method as claimed in claim 1. Advantageous embodiments of the invention may be found in the corresponding dependent claims.

According to claim 1, what is proposed is a method for determining an upholstery element from a set of mutually different upholstery elements in relation to a specific person, wherein the upholstery elements are able to be elastically deformed as a result of person-related loading on an upholstered surface of the respective upholstery element. The upholstery element accordingly, in a generic manner, has an upholstered surface that is able to be pushed in toward an upholstery core. This is achieved in that, on the one hand, the upholstered surface is stretchable and that the upholstery core, which is at least partially surrounded by the upholstered surface, is elastically deformable.

Such generic upholstery elements may be for example mattresses, cushions for seating furniture or cushions for vehicle seats.

According to the invention, a precomputed digital upholstery model is first provided for each upholstery element available for selection, for example in a digital data memory. Each upholstery model is assigned in this case to a corresponding upholstery element, the mechanical cushioning properties of which are to be represented by the respective upholstery model. The digital upholstery model in this case has a multiplicity of areas on the upholstered surface of the upholstery element assigned to the digital upholstery model, with a mechanical cushioning property being defined for each area. Such a mechanical cushioning property may for example define a restoring force upon deformation of the upholstered surface in the area in question. Such a restoring force may be defined for example as a function of a loading duration and/or a depth of penetration. Moreover, the restoring force may additionally also be defined as a function of how many neighboring areas of the area in question are loaded and thus deformed, which will be explained in more detail later on.

Such an area may in this case have a dimension in at least one direction of at least 0.1 cm, preferably at least 0.5 cm or particularly preferably 1 cm, 3 cm or up to 5 cm.

Depending on the upholstery size, even larger dimensions may also be expedient. By way of example, the surface dimension may thus be at least 0.1×0.1 cm, 0.5×0.5 cm, 1×1 cm, 3×3 or up to 5×5 cm (or even more), which is particularly advantageous for mattresses. The ratio of an elongate dimension in at least one direction of the upholstered surface to that of the respective area is at least 200 to 1, preferably at least 200 to 3, and more preferably at least 200 to 5 or more.

Furthermore, according to the invention, a body model of the person in question wishing to select an upholstery element is provided, wherein the body model defines a description of physiological body properties of the person in question. The physiological body properties may be for example biomechanical properties of the body, such as for example the behavior of the body when deformed on account of pressure being applied, for example by an upholstery element. Furthermore, the physiological body properties may also contain properties such as stature of the body, body weight and height, and thus anthropometric measurements. The body model that is provided may furthermore also contain personal usage preferences of the person in question as to how they would like to use the upholstery element.

For each upholstery model that is provided or a subset thereof (greater than/equal to 2), a virtual body loading on a selected body surface of the body of the person in question is then computed by way of a computing unit of a data processing system, and a loading index is determined based thereon and assigned to the respective upholstery element.

The virtual body loading in this case indicates, for the selected body surface of the body of the person in question, a mechanical loading in relation to person-related loading of the upholstered surface of the upholstery element assigned to the respective upholstery model. The person-related loading of the upholstered surface in this case means the use of the upholstery element with the selected body surface of the person in such a way that the selected body surface of the body of the person loads the upholstery element on the upholstered surface, and thus deforms it. In other words, the body surface makes contact (directly or with fabric in between) with the upholstered surface of the upholstery element. To determine the virtual body loading, however, the person-related loading of the upholstered surface is simulated with the selected body surface for this purpose in order thus to compute a virtual or simulated body loading without the selected body surface of the body actually having to physically load or try out the upholstered surface.

The virtual body loading is computed in this case as a function of the corresponding mechanical cushioning properties of the respective upholstery model and the physiological body properties of the body model of the person in question.

Depending on the computed virtual body loading of the respective upholstery model, at least one loading index is then ascertained or determined/computed and assigned to the upholstery element concerning the respective upholstery model. Both the loading index and the assignment to the upholstery element are stored in this case in a digital data memory.

According to the invention, at least one upholstery element is then determined from the set of mutually different upholstery elements as a function of the loading index assigned to the respective upholstery elements by way of the computing unit. The set of mutually different upholstery elements in this case comprises all those upholstery elements for which a corresponding loading index was computed previously. It is also possible in this case to select multiple upholstery elements whose loading index is for example above a predefined threshold value. An upholstery element for the person may then be selected manually or automatically from the set of determined upholstery elements.

The present invention thus makes it possible to determine an upholstery element from a set of different upholstery elements in relation to a specific person without the person in question having to physically try out the upholstery element. On the contrary, an optimum upholstery element is able to be determined and found based on the upholstery models of the respective upholstery elements and a body model.

Lengthy testing of such upholstery elements is therefore unnecessary. With the present invention, based on the digital upholstery models, on the one hand, and the body model, on the other hand, the person-related loading is simulated and a corresponding index is derived therefrom, by way of which index the optimal upholstery element is then able to be found.

According to one embodiment, provision is made for the virtual body loading to be computed such that, for different areas of the selected body surface, in each case a pressure loading on the body surface in the respective area is computed as a function of the corresponding mechanical cushioning properties of the respective upholstery model and the physiological body properties of the body.

For this purpose, for different areas of the selected body surface, in each case a pressure loading on the body surface in the respective area is computed as a function of the corresponding mechanical cushioning properties of the respective upholstery model and the physiological body properties of the body. All computed pressure loadings intended to act on the body surface are then combined into a virtual body loading and possibly stored in a data memory. Depending on the computed pressure loadings acting on the body surface, the at least one loading index is then computed and assigned to the corresponding upholstery element.

According to one embodiment, provision is made for the virtual body loading to be computed such that a biometric deformation of the body of the person in question is computed as a function of the corresponding mechanical cushioning properties of the respective upholstery model and the physiological body properties of the body. The type of deformation and/or the degree of deformation may in this case influence the loading index. It is thus conceivable for the loading index to be qualitatively lower the greater the degree of deformation or the more unusual the type of deformation (for example “bent” back).

According to one embodiment in this regard, provision may be made for the loading index to be computed as a function of a homogeneity and/or a statistical distribution of the pressure loadings and/or of the biomechanical deformations. It is thus conceivable for the loading index to characterize a higher (better) rating of the corresponding body/upholstery element combination the more homogeneous the pressure loading on the selected body surface by the upholstery element and/or the lower the biomechanical deformation.

According to one embodiment, provision is made for the body model to contain at least one upholstery loading preference of the person in question, wherein the body surface on which the computing of the pressure loading distribution is based is selected as a function of the at least one upholstery loading preference.

By way of example, when selecting a mattress, an upholstery loading preference may thus define whether the person in question prefers to sleep on their back, on their side or on their stomach. Based on this, that body surface of the body of the person that would (most frequently or to the greatest extent) load the upholstered surface of the upholstery element in relation to the upholstery loading preference is then selected. By way of example, if the upholstery loading preference of the person in question is defined such that the person in question prefers to sleep on their back, then the dorsal body surface of the body is selected. In the case of a preference for stomach sleeping, the ventral body surface of the body would be selected for this purpose.

The selected body surface within the meaning of the present invention is understood to mean that part of the body of the person with which the person would load the upholstered surface of an upholstery element. The selected body surface within the meaning of the present invention is therefore part of the entire surface of the body and is defined by corresponding areas or sections of the body.

According to one embodiment, provision is made for the mechanical cushioning properties to be specified in each case by a virtual spring force element in the corresponding area with a defined restoring force. Such a virtual spring force element may in this case be time-dependent, that is to say the restoring force changes over the loading duration. As an alternative or in addition, such a spring force element may however also be travel-dependent, that is to say the restoring force is dependent on the depth of penetration into the upholstery element.

According to one embodiment, provision is made in this regard for the mechanical cushioning properties to be defined in each case by the virtual spring force element of the corresponding area, on the one hand, and at least one virtual force element of a neighboring area, on the other hand, preferably four neighboring areas, particularly preferably all neighboring areas of a corresponding area.

This is because, when the upholstered surface is loaded in one area, the neighboring areas are also loaded indirectly due to the mechanical relationship and mechanical interaction, even when there is no direct loading from an object, that is to say no force is exerted on the upholstered surface in the respective neighboring area. This mechanical relationship between an area and its neighboring areas may in this case be defined in the respective digital upholstery model as a mechanical cushioning property for the respective area. As a result, for example, a restoring force is defined not only by the virtual spring force element of the respective area, but also by the mechanical relationship or by the mechanical interaction with the neighboring areas.

The mechanical relationship may in this case be defined in the upholstery model by an additional spring element between the areas, which additional spring element connects the first (main) area under consideration with the respective neighboring area. Provision may also be made in this case for not only the immediate neighboring area but also the neighboring area of the neighboring area to be considered, so as to create a type of mechanical chain of action between multiple areas. If for example the pressure loading on the body in a certain area is to be determined from the restoring force in this area, then not only the virtual spring force element of this area but also the spring force elements of the adjoining neighboring areas are taken into account depending on the defined mechanical relationship between the area under consideration and the neighboring areas, this resulting from the additional spring element.

According to one embodiment in this regard, provision is made for the restoring force of the virtual spring force elements of each upholstery element to be determined through a previous measurement of the restoring force in the respective areas in which the mechanical cushioning property is specified. In one embodiment in this regard, provision may also be made for not only the restoring force in the respective area to be determined through a previous measurement, but also for the mechanical relationship between the respective area and its neighboring areas to be determined through a corresponding measurement.

The restoring force may be determined for example, as will be shown in more detail later on, by loading the upholstered surface in each area with the aid of a mechanical stamp. The respective area may in this case be loaded with the stamp with a predefined force or to a predefined depth of penetration. The stamp here has the dimensions or extent of the defined area. In order for example to determine the mechanical relationship between the areas, provision may be made for the contact surface of the stamp not only to cover the area whose restoring force is to be determined, but to have a size or extent that also covers the neighboring areas. The surface area for additionally covering neighboring areas may thus for example be three times larger or five times larger than the stamp, which is intended to cover only a single area.

According to one embodiment, provision is made for body model to be provided such that, by virtue of at least one digital image of at least part of the body of the person in question first being recorded by way of a camera, body features are recognized from the at least one recorded digital image by way of an image processing unit, and the body model of the person is then created or supplemented on the basis of the recognized body features. The body of the person in question may thus be recorded from at least two perspectives, for example from a dorsal perspective, a ventral perspective and/or a lateral perspective. The digital image is analyzed by way of image processing in order to identify corresponding body features of the person. Such body features are for example the height, the estimated weight and the body shape and stature of the scanned person. The body model may then be created or supplemented from these extracted body features.

The object is also achieved according to the invention with a data processing system as claimed in claim 9 configured to perform the method described above, wherein the data processing system has a digital data memory for providing the upholstery models and the body model and a computing unit that is configured to compute the virtual body loading, the loading index and to determine the at least one upholstery element.

The object is also achieved according to the invention with the computer program as claimed in claim 10.

The object is also achieved according to the invention with the method for creating a digital upholstery model of a upholstery element as claimed in claim 11, wherein the digital upholstery model defines a respective mechanical cushioning property for a multiplicity of areas on the upholstered surface of the upholstery element. Such a digital upholstery model, as is able to be created by way of the described method, may in this case be used in the method described above for determining at least one upholstery element.

According to the invention, provision is made in this case for at least one force/time curve to be initially recorded for each area defined on the upholstered surface for which a mechanical cushioning property is to be defined in the upholstery model. In this case, a stamp is pressed onto the upholstered surface in the respective area and kept there for a selected time interval, during which the restoring force of the upholstery element is measured in the area in question over the selected time interval. Such an area measurement results in a multiplicity of measured values for the selected time interval, which measured values indicate the restoring force in the respective time step within the selected time interval. A force/time curve for the respective area may then be determined from these measured values.

After at least one force/time curve has then been determined in this way for each area, the digital upholstery model may then be created by determining the mechanical cushioning properties of the respective areas as a function of the recorded force/time curves of the respective areas. In the simplest embodiment, the mechanical cushioning properties are the force/time curves of the respective area.

According to one embodiment, provision is made for a first measurement run for recording first force/time curves to be performed using a first stamp and for at least one second measurement run for recording second force/time curves to be performed with a second stamp that is different from the first stamp, wherein the stamp surface, with which the stamp is pressed onto the upholstered surface, of the first stamp has a shape that is limited to the area to be examined, and the stamp surface of the second stamp has a shape that, in addition to the area to be examined, additionally covers at least one further neighboring area.

The respective mechanical cushioning property for the area in question may then be determined from the force/time curves concerning a specific area of the upholstered surface. This makes it possible to determine the mechanical relationships between an area and the neighboring areas when ascertaining the mechanical cushioning properties for a specific area.

The object is also achieved according to the invention with the device as claimed in claim 14 for creating a digital upholstery model of an upholstery element, configured to perform the method described above, wherein the device has a system for pressing a stamp onto an upholstered surface and a computing unit for creating the digital upholstery model.

The invention will be explained in more detail by way of example on the basis of the attached figures, in which, in each case in an exemplary embodiment:

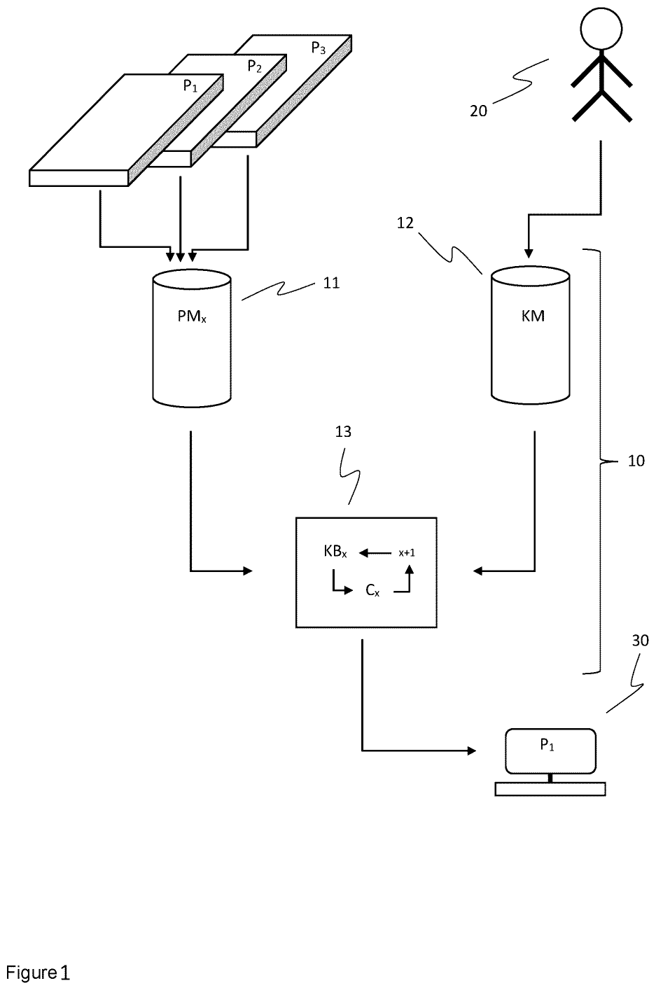

FIG. 1 shows a schematic illustration of the invention in a basic form;

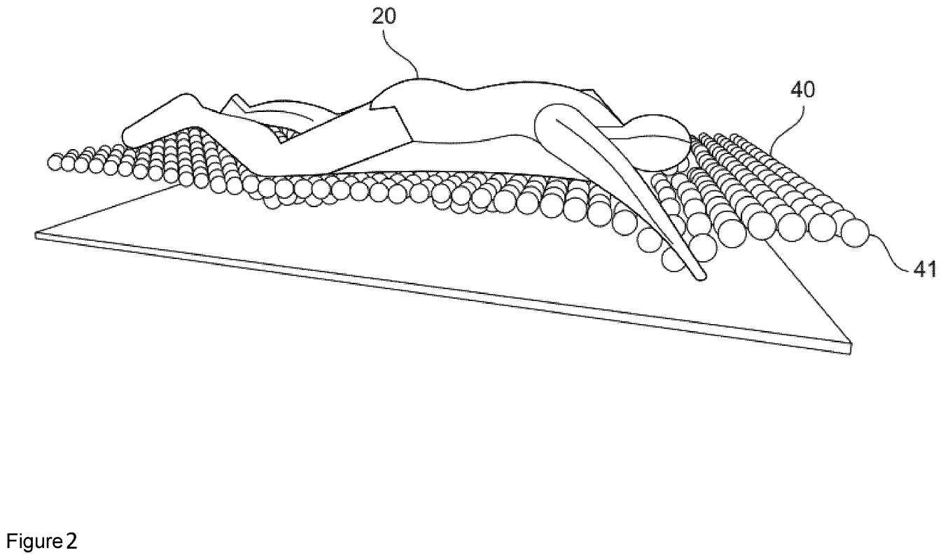

FIG. 2 shows an illustration of a simulation of the loading of a cushion surface with a body;

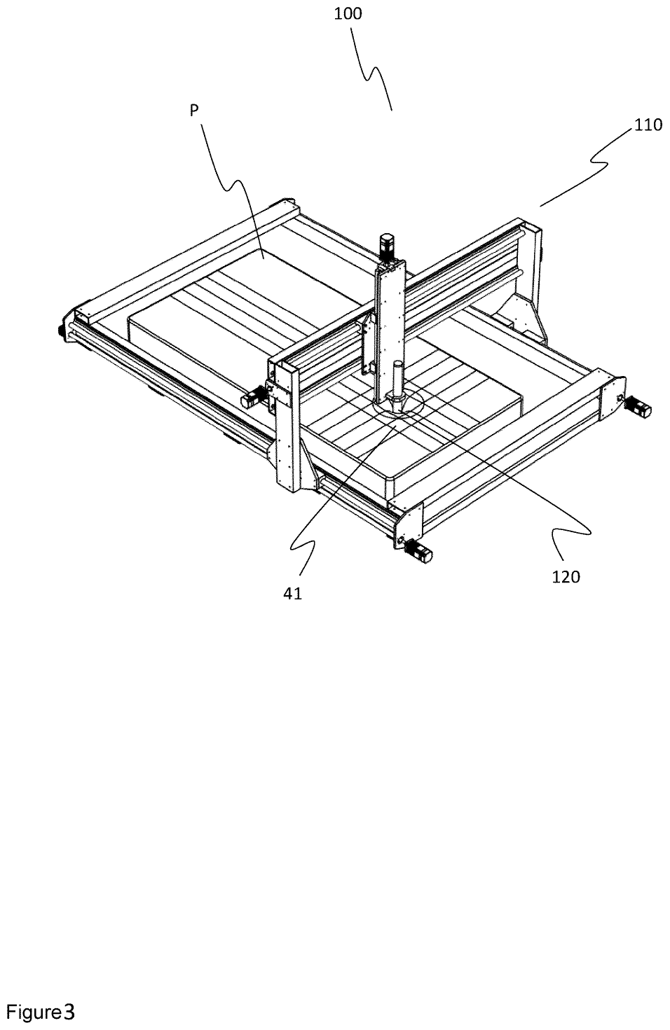

FIG. 3 shows a schematic illustration of the measuring system;

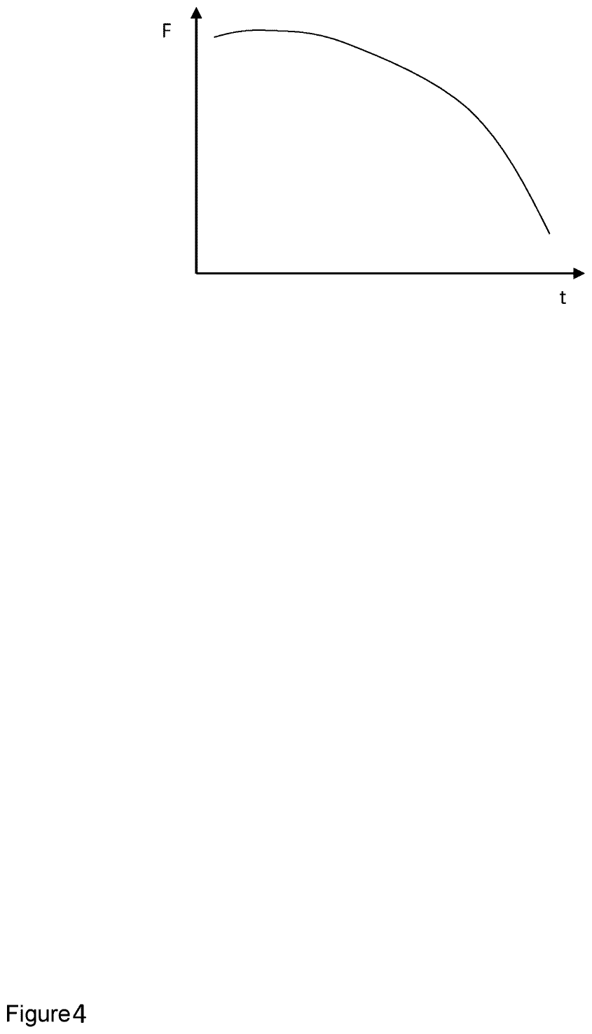

FIG. 4 shows an exemplary illustration of a force/time curve.

FIG. 1 shows a schematic, highly simplified illustration of a device 10, which represents a data processing system. The data processing system 10 has a first digital data memory 11 and a second digital data memory 12. Both the first digital data memory 11 and the second digital data memory 12 are connected in this case to a computing unit 13, which is designed to carry out the method according to the invention.

The first digital data memory 11 stores a multiplicity of digital upholstery models PMₓ, each of which is assigned to a corresponding upholstery element Pₓ. The digital upholstery model PM₁ is in this case assigned to the upholstery element P1, the digital upholstery model PM₂ is assigned to the upholstery element P2, etc. For the sake of simplicity, only three upholstery models and three upholstery elements are shown in FIG. 1. As will still be shown later on, a corresponding upholstery model PM has been created from the respective upholstery element P and saved. The upholstery models P in the exemplary embodiment of FIG. 1 are mattresses.

The second digital data memory 12 stores a body model KM of a body of a person 20, which has likewise been created beforehand. The body model KM in this case contains a description of physiological body properties of the person 20, and describes in particular biomechanical relationships of the body. The body model KM may in this case be created for example based on a recording of the person 20 from various perspectives, by extracting corresponding body features from the recorded image data.

In the exemplary embodiment of FIG. 1, the first data memory 11 and the second data memory 12 are depicted as separate data memories. It is conceivable here for there to be a physical separation between the two data memories. However, it is also conceivable for the first data memory and the second data memory to be physically present on one and the same data memory, and for there to be only logic separation.

The computing unit 13 of the data processing system 10 is in this case connected to a computer 30, which is operated for example by the person 20. The person 20 in this case wishes to select an upholstery element P from the set of upholstery elements Mp={P₁, P₂, P₃}. For this purpose, the person 20 has, for example using the computer 30, first transmitted corresponding data to the computing unit 13, such as for example usage preferences of the desired upholstery element and possibly image data, in order to generate a corresponding body model KM therefrom. The body model KM of the person 20 is in this case created by the computing unit 13 and stored in the second digital data memory 12. However, it is also conceivable for the body model KM in question to already have been created in advance.

Based on the body model KM, a virtual body loading KBₓ on a selected body surface of the body is then computed for each upholstery model PMₓ. This virtual body loading KBₓ in this case indicates the behavior and/or properties of the body if the body of the person 20 in question were to physically load the corresponding upholstery element Pₓ with the selected body surface. Based on the virtual body loading KBₓ, a loading index Cₓ is then computed, this indicating a rating of the combination of the person 20 and the corresponding upholstery element Pₓ.

Based on the determined loading index Cₓ, the upholstery element that has the best rating is then selected. This is then displayed to the person on the computer 30.

FIG. 2 shows the loading of a virtual upholstered surface 40 of an upholstery model PMₓ with the body of the person 20 in order in the process to ascertain the virtual body loading on the body 20. For this purpose, the virtual upholstered surface 40 has a multiplicity of areas 41 for which a respective mechanical cushioning property is defined in the upholstery model PMₓ. This mechanical cushioning property may in this case for example be a restoring force which, when the upholstered surface 40 is loaded in the respective area 41, exerts a force on the body 20 causing the loading.

The body loading on the body 20 may be computed from this simulation, as shown in FIG. 2. For this purpose, it is possible to determine for example the magnitude of the restoring force of the individual areas 41 acting on the body and/or the magnitude of the deformation of the body 20. Both properties of the body loading result in this case from the mechanical cushioning properties of the upholstery model, on the one hand, and the body model with the physiological and biomechanical body properties.

A loading index may then be derived from the virtual body loading.

FIG. 3 shows a system 100 that may be used to measure an upholstery element P such that a digital upholstery model is able to be created therefrom, as described above. For this purpose, the upholstery model P is placed in the system 100, with a gantry arm 110 being able to move a stamp 120 provided as an end effector in relation to the surface of the upholstery element P.

The stamp 120 is then pressed onto the upholstered surface of the upholstery element P in respective different areas 41 of the upholstered surface for which a respective mechanical cushioning property is to be determined, and kept there for a certain time interval. During this time interval, the restoring force is measured and stored in a force/time curve. If a corresponding area 41 of the upholstered surface has been measured, then the stamp 21 is aligned with the next area and pressed onto the upholstered surface again until the entire upholstered surface of the upholstery element P has been measured in this way.

In the example of FIG. 3, the stamp 120 has the size of a corresponding area 41 and essentially covers said area almost completely. After the entire upholstered surface of the upholstery element P has been measured with this first stamp 120, the stamp 120 is replaced by a second stamp (not illustrated), which for example covers more than one area 41. The measurement run described above is then performed again with this second stamp. This makes it possible to acquire the mechanical relationships between neighboring areas.

FIG. 4 shows, by way of example, one such force/time curve as would be able to be determined for example at the position of an area 41.

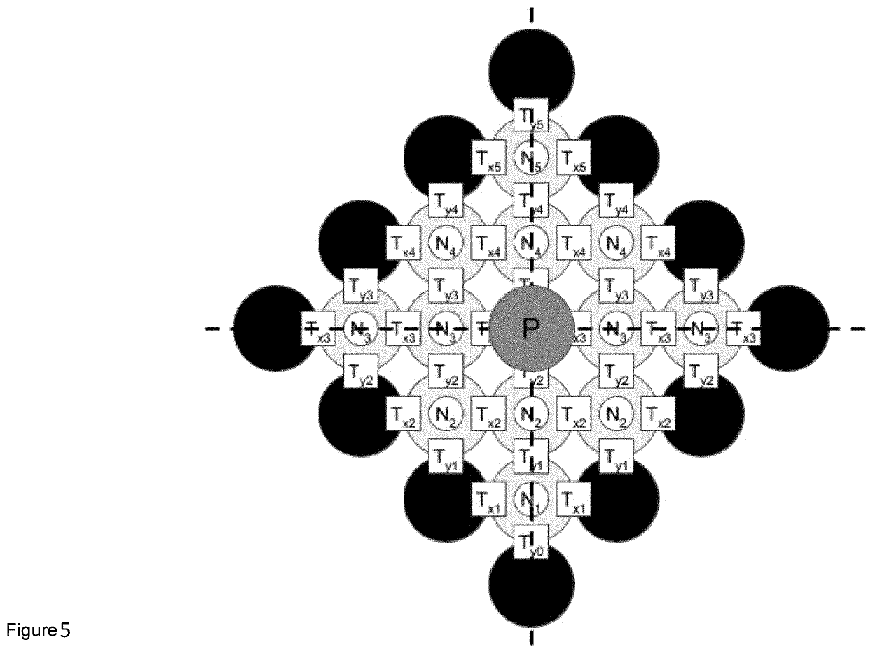

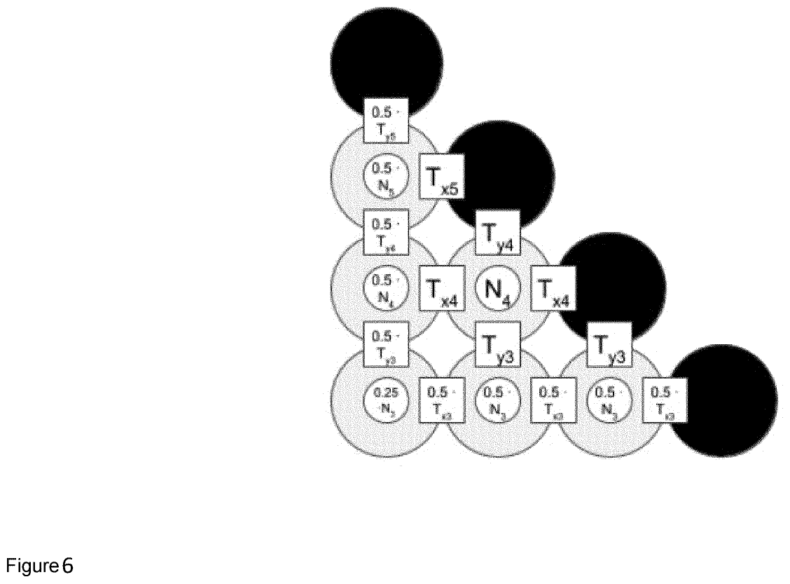

The equations for solving the mechanical mattress model may, in one embodiment, be based on two assumptions. On the one hand, linear symmetry is assumed along the measurement line (vertical line of symmetry in FIG. 5). The equivalent circuit diagram for the springs may thereby be reduced to half the size. On the other hand, it is assumed that the mutual influence of the areas 41 in front of and behind the lateral center line of the measurement point is negligible. The equivalent circuit diagram for the springs will thereby be further reduced to a quarter (see FIG. 6). In this case too, the springs lying on this center line must be adjusted.

The resulting general equation for the equivalent circuit diagram of the quarter is:

$${M}_{quarter} ( N , {T}_{x} , {T}_{y} , h , v ) = v \cdot h \cdot {N}_{0} + {K}_{a 3} + {k}_{8} \qquad ( 1 )$$

where N₀ is the main spring at the measurement point (or the spring at position 0 of the array of springs passed to the quarter computing function). v and h are factors considering the division along the measurement line (v) and the line (h) perpendicular thereto. For the various protocols, either 0.5 or 1.0 should be specified for v and h, depending on how many main springs the stamp covers. Kₐ₉ and k₃₀ result from the two paths from the center node (forward and sideways).

To obtain this equation, the equivalent circuit diagram is broken down using the same rules as for capacitors in an electrical circuit diagram, mainly using simplifying springs in series with:

$${k}_{series} = \frac{{k}_{1} \cdot {k}_{2}}{{k}_{1} + {k}_{2}} \qquad ( 2 )$$

and Y−Δ subnetworks with:

$$\begin{matrix}{k}_{Δ a} = \frac{\frac{1}{{k}_{Y 2}}}{\frac{1}{{k}_{Y 1}} \cdot \frac{1}{{k}_{Y 2}} + \frac{1}{{k}_{Y 2}} \cdot \frac{1}{{k}_{Y 3}} + \frac{1}{{k}_{Y 3}} \cdot \frac{1}{{k}_{Y 1}}} & ( 3 ) \\ {k}_{Δ b} = \frac{\frac{1}{{k}_{Y 3}}}{\frac{1}{{k}_{Y 1}} \cdot \frac{1}{{k}_{Y 2}} + \frac{1}{{k}_{Y 2}} \cdot \frac{1}{{k}_{Y 3}} + \frac{1}{{k}_{Y 3}} \cdot \frac{1}{{k}_{Y 1}}} & ( 4 ) \\ {k}_{Δ c} = \frac{\frac{1}{{k}_{Y 1}}}{\frac{1}{{k}_{Y 1}} \cdot \frac{1}{{k}_{Y 2}} + \frac{1}{{k}_{Y 2}} \cdot \frac{1}{{k}_{Y 3}} + \frac{1}{{k}_{Y 3}} \cdot \frac{1}{{k}_{Y 1}}} & ( 5 )\end{matrix}$$

Springs aligned in parallel are added.

The first Y−Δ subnetwork is solved by:

$$\begin{matrix}{k}_{a 1} = \frac{\frac{1}{{T}_{y 0}}}{\frac{1}{{T}_{x 1}} \cdot \frac{1}{{T}_{y 0}} + \frac{1}{{T}_{y 0}} \cdot \frac{1}{( {N}_{1} + {T}_{x 1} + {T}_{y 1} )} + \frac{1}{( {N}_{1} + {T}_{x 1} + {T}_{y 1} )} \cdot \frac{1}{{T}_{x 1}}} & ( 6 ) \\ {k}_{b 1} = \frac{\frac{1}{( {N}_{1} + {T}_{x 1} + {T}_{y 1} )}}{\frac{1}{{T}_{x 1}} \cdot \frac{1}{{T}_{y 0}} + \frac{1}{{T}_{y 0}} \cdot \frac{1}{( {N}_{1} + {T}_{x 1} + {T}_{y 1} )} + \frac{1}{( {N}_{1} + {T}_{x 1} + {T}_{y 1} )} \cdot \frac{1}{{T}_{x 1}}} & ( 7 ) \\ {k}_{c 1} = \frac{\frac{1}{{T}_{x 1}}}{\frac{1}{{T}_{x 1}} \cdot \frac{1}{{T}_{y 0}} + \frac{1}{{T}_{y 0}} \cdot \frac{1}{( {N}_{1} + {T}_{x 1} + {T}_{y 1} )} + \frac{1}{( {N}_{1} + {T}_{x 1} + {T}_{y 1} )} \cdot \frac{1}{{T}_{x 1}}} & ( 8 )\end{matrix}$$

A number of substitutions may then be made:

$$\begin{matrix}{k}_{0} = \frac{( v \cdot {T}_{y 1} ) \cdot ( v \cdot {N}_{2} + {T}_{x 2} + v \cdot {T}_{y 2} )}{( v \cdot {T}_{y 1} ) + ( v \cdot {N}_{2} + {T}_{x 2} + v \cdot {T}_{y 2} )} & ( 9 ) \\ {k}_{1} = \frac{( h \cdot {T}_{x 0} ) \cdot ( h \cdot {N}_{2} + {T}_{x 0} + h \cdot {T}_{y 0} )}{( h \cdot {T}_{x 0} ) + ( h \cdot {N}_{2} + {T}_{x 0} + h \cdot {T}_{y 0} )} & ( 10 ) \\ {k}_{2} = v \cdot {N}_{1} + {k}_{0} & ( 11 ) \\ {k}_{3} = h \cdot {N}_{0} + {k}_{1} & ( 12 ) \\ {k}_{4} = {k}_{2} + {k}_{a 1} & ( 13 ) \\ {k}_{5} = kc 1 + k 3 & ( 14 )\end{matrix}$$

to solve the second Y−Δ subnetwork:

$$\begin{matrix}{k}_{a 3} = \frac{\frac{1}{{k}_{b 1}}}{\frac{1}{v \cdot {T}_{y 0}} \cdot \frac{1}{{k}_{b 1}} + \frac{1}{{k}_{b 1}} \cdot \frac{1}{{k}_{4}} + \frac{1}{{k}_{4}} \cdot \frac{1}{v \cdot {T}_{y 0}}} & ( 15 ) \\ {k}_{b 3} = \frac{\frac{1}{{k}_{4}}}{\frac{1}{v \cdot {T}_{y 0}} \cdot \frac{1}{{k}_{b 1}} + \frac{1}{{k}_{b 1}} \cdot \frac{1}{{k}_{4}} + \frac{1}{{k}_{4}} \cdot \frac{1}{v \cdot {T}_{y 0}}} & ( 16 ) \\ {k}_{c 3} = \frac{\frac{1}{v \cdot {T}_{y 0}}}{\frac{1}{v \cdot {T}_{y 0}} \cdot \frac{1}{{k}_{b 1}} + \frac{1}{{k}_{b 1}} \cdot \frac{1}{{k}_{4}} + \frac{1}{{k}_{4}} \cdot \frac{1}{v \cdot {T}_{y 0}}} & ( 17 )\end{matrix}$$

With a further number of substitutions, the network is finally solved:

$${k}_{6} = {k}_{a 3} + {k}_{5} \qquad ( 18 )$$

$${k}_{7} = {k}_{b 3} + h \cdot {T}_{x 0} \qquad ( 19 )$$

$${k}_{8} = \frac{{k}_{6} \cdot {k}_{7}}{{k}_{6} + {k}_{7}} \qquad ( 20 )$$

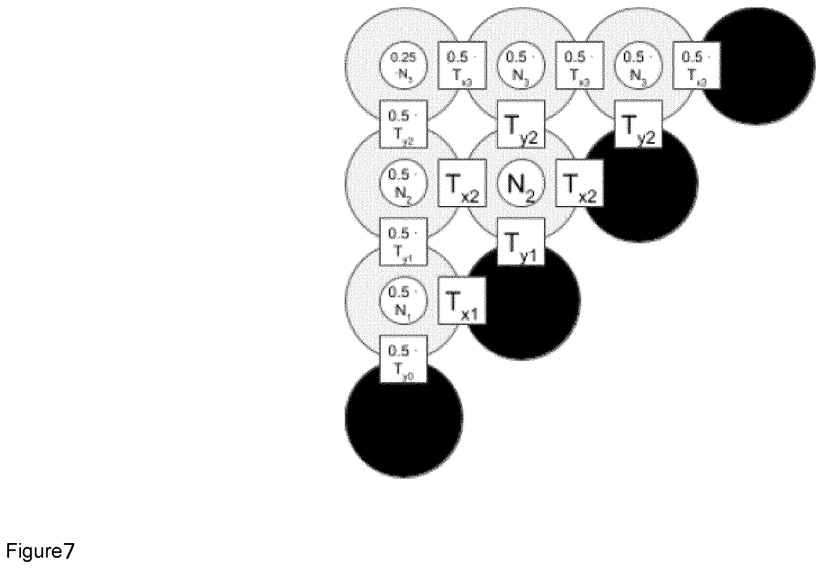

As with N₀, the input values for these formulas Nᵢ, Tₓᵢ and t_{yi} are the values for the main spring and the spring connection (mechanical relationship) of the two neighboring areas in the x-direction and those in the y-direction in the form of a one-dimensional array. For the backward term, the order of the elements of the input array is reversed (cf. FIG. 7). The above equations may thereby be used for any protocol. There are always two identical forward terms M_{quarter, forward} (that is to say in the direction of propagation of the probe during the measurement process) and two identical backward terms M_{quarter, backward}.

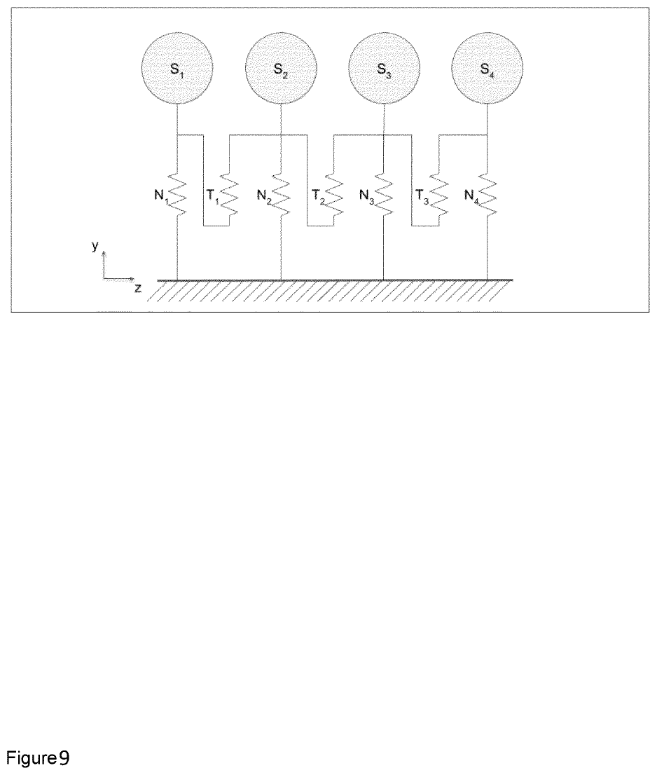

The mechanical relationship between the individual spring elements may be seen in its basic structure in FIG. 9.

For protocol 0 (single-size probe), these four terms are computed with v=h=0.5 in equation (1):

$${M}_{p 0 , general} = 2 \cdot {M}_{quarter , forward} + 2 \cdot {M}_{quarter , backward} \qquad ( 21 )$$

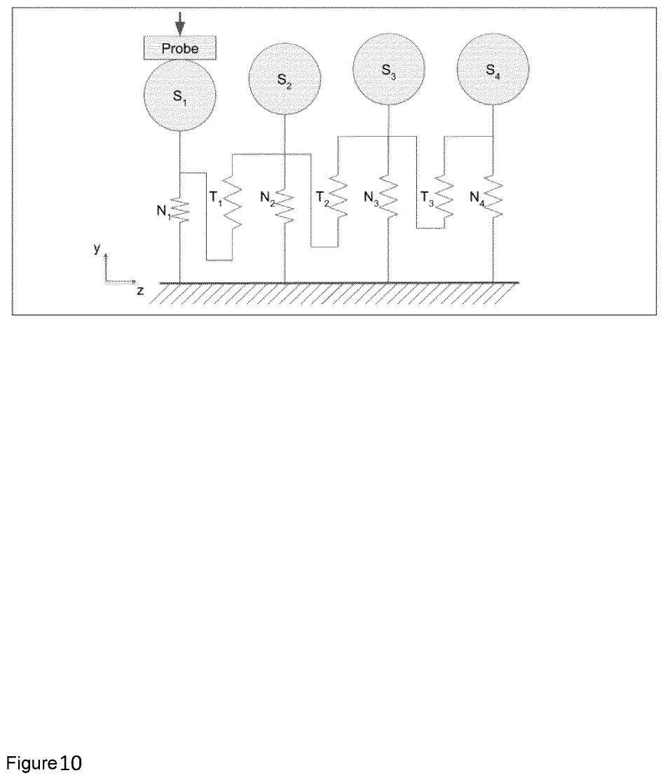

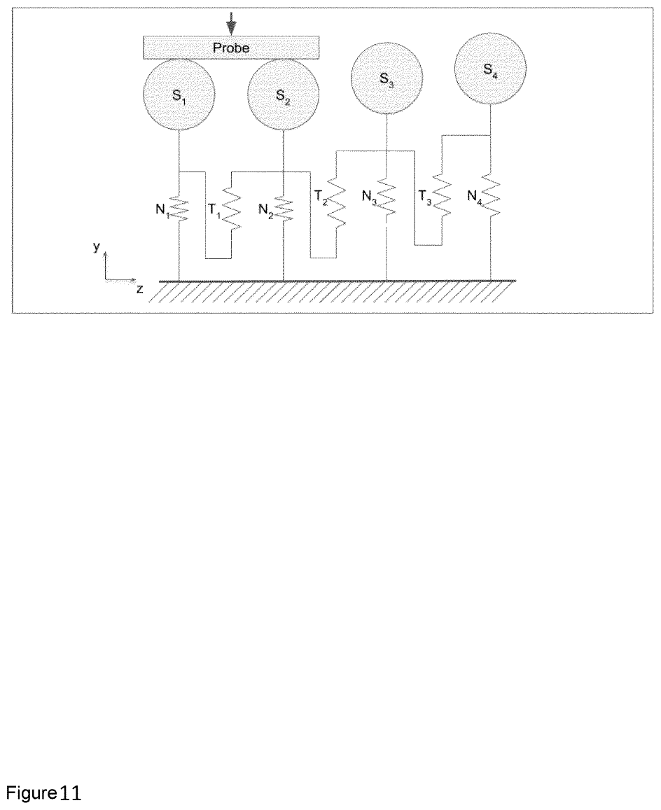

For protocol 1 (double-size test probe), the following same equation is used. However, the inputs for equation (1) are h=1.0 and v=0.5, and the input fields for the forward term are shifted up one element. The element of Ty at position 0 is thereby skipped in the system of equations (cf. FIGS. 10 and 11). This is the basis of the overall approach.

$${M}_{p 1 , general} = 2 \cdot {M}_{quarter , forward} + 2 \cdot {M}_{quarter , backward} \qquad ( 22 )$$

The same applies to protocol 3 (double-size test probe, rotated 90°). The same equation may be used here. However, the inputs to equation (1) are h=0.5 and v=1.0. The input fields are not moved.

$${M}_{p 3 , general} = 2 \cdot {M}_{quarter , forward} + 2 \cdot {M}_{quarter , backward} \qquad ( 23 )$$

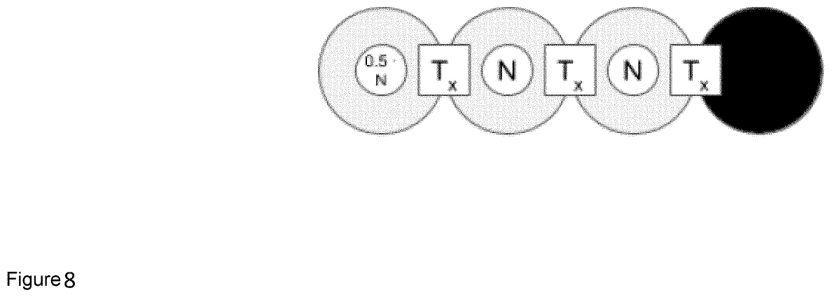

For protocol 2 (triple-size probe), it is the same equation again. However, a middle term is added (cf. FIG. 8) that is not covered by the quarter equation:

$${M}_{p 2 , general} = 2 \cdot {M}_{quarter , forward} + 2 \cdot {M}_{quarter , backward} + 2 \cdot {M}_{middle} \qquad ( 24 )$$

wherein

$${M}_{middle} ( N , {T}_{x} ) = 0.5 \cdot N + f ( 2 ) \qquad ( 25 )$$

with

$$f = \{ \begin{matrix}\frac{N \cdot {T}_{x}}{N + {T}_{x}} + f ( n - 1 ) , & if n \geq 1 \\ {T}_{x} , & if n = 1 \\ 0 , & otherwise\end{matrix} \qquad ( 26 )$$

FIGS. 9 and 10 in this case show the connection between a first area S₁ and a mechanically related second area S₂ (neighboring area), which in turn is operatively connected to a third area S₃. Each area Sₙ is defined in this case by a virtual spring element Nₙ, wherein a first area Sₙ is operatively connected to its respective neighboring area Sₙ₊₁ via an additional spring element Tₙ that defines the mechanical connection between the areas. In the upholstery model, the restoring force of an area Sₙ is thus dependent not only on the spring element Nₙ but also on the mechanical relationship Tₙ with the neighboring area Sₙ₊₁ and its spring element Nₙ₊₁.

### LIST OF REFERENCE SIGNS

10 device/data processing system
11 first data memory
12 second data memory
13 computing unit
20 person
30 computer
40 (virtual) upholstered surface
41 areas of the upholstered surface
100 system
110 gantry arm
120 stamp
Pₓ upholstery element
p.mₓ upholstery model
KBₓ virtual body loading
Cₓ loading index
KM body model

1. A method for determining at least one upholstery element from a set of mutually different upholstery elements in relation to a specific person, wherein each upholstery element of the set of upholstery elements are able to be elastically deformed as a result of person-related loading on an upholstered surface of the respective upholstery element, comprising:
providing a plurality of precomputed digital upholstery models that are each assigned to a specific upholstery element of the set of upholstery elements, wherein each digital upholstery model defines a respective mechanical cushioning property for a multiplicity of areas on the upholstered surface;
providing a body model of the specific person, wherein the body model contains a description of physiological body properties of the specific person;
wherein, for each provided precomputed digital upholstery model or a subset thereof, a computing unit of a data processing system performs individually
computing a virtual body loading on a selected body surface of a body of the specific person in relation to person-related loading of the upholstered surface of the upholstery element (Pₓ) assigned to respective upholstery model as a function of corresponding mechanical cushioning properties of the respective upholstery model and the description of the physiological body properties of the body model of the specific person, and
determining at least one loading index as a function of the computed virtual body loading and assigning the at least one loading index to the upholstery element concerning the respective upholstery model;
wherein at least one specific upholstery element is then determined from the set of mutually different upholstery elements as a function of the loading indices assigned to the respective upholstery elements by the computing unit.

2. The method as claimed in claim 1, wherein the virtual body loading is computed such that, for different areas of the selected body surface, in each case a pressure loading on the body surface in the respective area is computed as a function of the corresponding mechanical cushioning properties of the respective upholstery model and the physiological body properties of the body of the specific person.

3. The method as claimed in claim 1 wherein the virtual body loading is computed such that a biometric deformation of the body of the specific person is computed as a function of the corresponding mechanical cushioning properties of the respective upholstery model and the physiological body properties of the body of the specific person.

4. The method as claimed in claim 1 wherein the body model contains at least one upholstery loading preference of the specific person, wherein the body surface on which the computing of the virtual body loading is based is selected as a function of the at least one upholstery loading preference.

5. The method as claimed in claim 1 wherein the mechanical cushioning properties are specified in each case by a virtual spring force element of their area with a defined restoring force.

6. The method as claimed in claim 5, wherein the mechanical cushioning properties are specified in each case by the virtual spring force element of its area and a virtual spring force element of at least one neighboring area.

7. The method as claimed in claim 5 wherein a restoring force of the virtual spring force elements of each upholstery element (Pₓ) is determined through a previous measurement of the restoring force in the respective areas at which the mechanical cushioning property is specified.

8. The method as claimed in claim 1 wherein the body model is provided such that, by at least one digital image of at least part of the body of the specific person first being recorded by a camera, body features are recognized from the at least one recorded digital image by an image processing unit, and the body model (KM) of the specific person is then created or supplemented based on the recognized body features.

9. A data processing system configured to perform the method as claimed in claim 1, comprising, having a digital data memory for providing the upholstery models and the body model, and a computing unit configured to compute the virtual body loading, the pressure loading indices, and to determine the at least one upholstery element.

10. A computer program having program code encoded on a non-transient computer readable medium configured to perform the method as claimed in claim 1 when the computer program is executed on a data processing system.

11. A method for creating a digital upholstery model of an upholstery element that is able to be elastically deformed as a result of person-based loading on an upholstered surface of the upholstery element, wherein the digital upholstery model defines a respective mechanical cushioning property for a multiplicity of areas on the upholstered surface of the upholstery element, comprising:
recording at least one force/time curve for each area of the upholstered surface for which a mechanical cushioning property in the upholstery model is to be defined, such that a stamp is pressed onto the upholstered surface in the respective area and kept there for a selected time interval, wherein during the selected time interval a restoring force of the upholstery element is measured in the respective area over the selected time interval,
creating the digital upholstery model by determining the mechanical cushioning properties of the respective areas as a function of the recorded force-time curves of the respective areas.

12. The method as claimed in claim 11, wherein a first measurement run for recording first force/time curves is performed using a first stamp and at least one second measurement run for recording second force/time curves is performed with a second stamp that is different from the first stamp, wherein the stamp surface, with which the first stamp is pressed onto the upholstered surface has a shape that is limited to an area to be examined, and the stamp surface of the second stamp has a shape that, in addition to the area to be examined, additionally covers at least one neighboring area.

13. The method as claimed in claim 11 wherein a respective upholstery model is created for a multiplicity of mutually different upholstery elements, wherein the created upholstery models are provided to the method for determining an upholstery element from the set of mutually different upholstery elements as claimed in claim 1.

14. A device for creating a digital upholstery model of an upholstery element, configured to perform the method as claimed in claim 11, comprising a system for pressing the stamp onto the upholstered surface and a computing unit for creating the digital upholstery model.
